(19) United States
(12) Patent Application Publication
(10) Pub. No.: US 2018/0122116 A1
(43) Pub. Date: May 3, 2018

(54) TRANSPARENT DISPLAY APPARATUS HAVING SCREEN DIRECTION SWITCHING FUNCTION

(71) Applicant: KIMIN ELECTRONIC CO., LTD., Gumi-si (KR)

(72) Inventor: Se-Bong Jang, Gumi-si (KR)

(73) Assignee: KIMIN ELECTRONIC CO., LTD.

(21) Appl. No.: 15/350,296

(22) Filed: Nov. 14, 2016

(30) Foreign Application Priority Data
Oct. 28, 2016 (KR) 10-2016-0142177

(51) Int. Cl. G06T 11/60; G06F 3/01; G02F 1/13; G02F 1/133; G02F 1/1335; G02F 1/29

(52) U.S. Cl. CPC G06T 11/60; G06F 3/01; G02F 1/1323; G02F 2001/133302; G02F 1/13362; G02F 1/133528; G02F 1/29; G02F 1/13306

(57) ABSTRACT

Disclosed is a transparent display apparatus having a screen direction switching function that is capable of selectively switching a display screen based on settings of polarization in the forward and rearward directions of the transparent display apparatus to flexibly change the output type of the display screen and that is capable of very efficiently outputting the display screen based on the surrounding conditions, such as the time of day.

### REFERENCE TO RELATED APPLICATIONS

This application is based upon and claims the priority benefit of Korean Patent Application No. 10-2016-0142177 filed on Oct. 28, 2016, the entire contents of which are incorporated herein by reference.

### FIELD OF THE INVENTION

The present invention relates to a transparent display apparatus having a screen direction switching function, and more particularly to a transparent display apparatus having a screen direction switching function that is capable of selectively switching a display screen based on polarization settings in the forward and rearward directions of the transparent display apparatus to flexibly change the output type of the display screen and that is capable of very efficiently outputting the display screen based on the conditions of the surroundings, such as the time of day.

### BACKGROUND OF THE INVENTION

In general, electronic equipment, such as televisions, monitors, navigation devices, and laptop computers, which input and output information, is equipped with various kinds of display apparatuses that visually display the processing results or information based on input data signals. In addition, there has been active research into a transparent display apparatus configured to display various kinds of image information on transparent glass, such as a window, the door of a showcase refrigerator, and a display case, which is transparent such that objects can be seen therethrough.

Since an image of the surroundings overlaps an image displayed on the conventional transparent display apparatus in the case in which the transparent display apparatus is used, however, the visibility of the image displayed on the transparent display apparatus is reduced. Furthermore, the visibility of the image of the surroundings, e.g. objects behind the transparent display apparatus, is also reduced.

In order to solve the above problems, a transparent display apparatus including an image display unit for displaying an image using an element made of a transparent material and a blind panel coupled to the lower part of the image display unit, wherein the blind panel transmits light in a visible light band, among light that passes through the image display unit and is emitted to the blind panel, or reflects the light in the visible light band to the image display unit in order to selectively transmit or reflect the light in the visible light band, thereby preventing overlap between an image output from the transparent display apparatus and an image of the surroundings and improving the visibility of the image output from the transparent display apparatus, is disclosed in Korean Registered Patent No. 10-1272498 (Jun. 3, 2013).

In addition, a transparent plasma display panel having a mirror function, including an upper panel and a lower panel for constituting a single cell together with the upper panel, wherein the lower panel includes a transparent fluorescent layer disposed between transparent partition walls, a dielectric spacer layer disposed under the transparent fluorescent layer for preventing direct contact between the transparent fluorescent layer and a metal nano film, and the metal nano film formed under the dielectric spacer layer, the metal nano film configured to perform the mirror function when no image is displayed on the transparent plasma display panel and to generate surface plasmon resonance such that the intensity of light emitted from the transparent fluorescent layer is increased when an image is displayed on the transparent plasma display panel, thereby improving the intensity and efficiency of light emitted from the transparent plasma display panel, is disclosed in Korean Registered Patent No. 10-1222853 (Jan. 10, 2013).

In the display apparatus disclosed in Korean Registered Patent No. 10-1272498, however, any one selected from between an image displayed as the result of the transmission or reflection of light and the background of the surrounding is selectively focused on. As a result, in the case in which light emitted toward the display apparatus is transmitted through the display apparatus, as in the conventional art, it is not possible to view the image displayed on the screen in the daytime. On the other hand, in the case in which the light is reflected by the display apparatus, the display apparatus lose its function as transparent glass, with the result that it is not possible to view the background of the surroundings.

In addition, in the transparent plasma display panel disclosed in Korean Registered Patent No. 10-1222853, the mirror function or the display function is selectively performed depending on whether or not an image is displayed. As a result, the panel is affected by light from the surroundings, particularly light from the rear of the panel, while the image is output on the panel, whereby the image is not clearly output on the panel.

Therefore, there is an urgent necessity for a transparent display apparatus that is capable of displaying an image depending on changes in the surroundings while effectively exhibiting various kinds of functions.

### SUMMARY OF THE INVENTION

Therefore, the present invention has been made in view of the above problems, and it is an object of the present invention to provide a transparent display apparatus having a screen direction switching function that is capable of selectively setting a screen output mode using a controller for turning on or off a transparent display unit and polarized light source units disposed at the front and the rear of the transparent display unit for performing polarizing functions, thereby diversifying screen output directions and screen output types and improving the visibility of the screen.

In accordance with the present invention, the above and other objects can be accomplished by the provision of a transparent display apparatus having a screen direction switching function including a transparent display unit including glass substrates, each of which is made of a transparent material, and an image output means disposed between the glass substrates in the state of being mounted to inner surfaces of the glass substrates for outputting an image signal, a first polarized light source unit disposed at the front of the transparent display unit, the first polarized light source unit being provided at one end thereof with a light emitting diode (LED) lamp, the first polarized light source unit being configured to perform a polarizing function toward the front of the transparent display unit using light emitted from the LED lamp, a second polarized light source unit disposed at the rear of the transparent display unit, the second polarized light source unit being provided at one end thereof with a light emitting diode (LED) lamp, the first polarized light source unit being configured to perform a polarizing function toward the rear of the transparent display unit using light emitted from the LED lamp, and a setting controller for performing control such that the transparent display unit, the first polarized light source unit, and the second polarized light source unit are individually powered on or off, the setting controller being configured to apply control signals to the transparent display unit, the first polarized light source unit, and the second polarized light source unit such that a screen output state in a forward direction or a rearward direction of the transparent display apparatus is set for each mode.

The first polarized light source unit and the second polarized light source unit may each include a polarizing plate member disposed so as to correspond to the transparent display unit, the polarizing plate member being provided at a side thereof with a plurality of LED lamps, and the polarizing plate member may be made of poly methyl methacrylate (PMMA).

The setting controller may perform control such that the transparent display unit is powered on or off in order to select a transparent mode or a shading mode in the state in which the screen is output in the forward direction or the rearward direction of the transparent display apparatus through the first polarized light source unit and the second polarized light source unit.

In the transparent mode, in which the transparent display unit is powered on, the setting controller may perform control such that the first polarized light source unit is turned on and the second polarized light source unit is turned off in order to switch to a state in which the screen is output from the rear of the transparent display unit based on the polarizing function of the first polarized light source unit. In addition, in the transparent mode, in which the transparent display unit is powered on, the setting controller may perform control such that the first polarized light source unit is turned off and the second polarized light source unit is turned on in order to switch to a state in which the screen is output from the front of the transparent display unit based on the polarizing function of the second polarized light source unit.

In the transparent mode, in which the transparent display unit is powered on, the setting controller may perform control such that both the first polarized light source unit and the second polarized light source unit are turned on in order to execute an illumination mode at the front and the rear of the transparent display unit.

In the shading mode, in which the transparent display unit is powered off, the setting controller may perform control such that the first polarized light source unit is turned off and the second polarized light source unit is turned on in order to execute an illumination mode on the second polarized light source unit while maintaining the shading mode on the first polarized light source unit. In addition, in the shading mode, in which the transparent display unit is powered off, the setting controller may perform control such that the first polarized light source unit is turned on and the second polarized light source unit is turned off in order to execute an illumination mode on the first polarized light source unit while maintaining the shading mode on the second polarized light source unit.

In the shading mode, in which the transparent display unit is powered off, the setting controller may perform control such that both the first polarized light source unit and the second polarized light source unit are turned on in order to execute an illumination mode in both the forward direction and the rearward direction of the transparent display apparatus.

In the transparent display apparatus having the screen direction switching function with the above-stated construction according to the present invention, the first polarized light source unit, which has a polarizing function, and the second polarized light source unit, which also has a polarizing function, are disposed at the front and the rear of the transparent display unit, respectively, such that the state in which the screen is output in the forward direction and/or the rearward direction is set for each mode. Consequently, it is possible to output various kinds of screens based on a mode that is flexibly set according to circumstances at the front and the rear of the transparent display unit and to greatly improve the visibility of the screen irrespective of the surrounding conditions, such as the time of day.

In addition, in the transparent display apparatus having the screen direction switching function with the above-stated construction according to the present invention, it is possible to select the transparent mode or the shading mode in the state in which the screen is output from the front and the rear of the transparent display unit. In the case in which the transparent display apparatus is provided as a window type transparent display apparatus, therefore, it is possible to greatly improve the utility and functionality of the product while constituting appropriate transparent and shading environments based on the surrounding conditions, such as the time of day.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram schematically showing an embodiment of the present invention;

FIG. 2 is an exploded perspective view schematically showing the embodiment of the present invention;

FIG. 3 is a sectional view schematically showing the embodiment of the present invention; and

FIG. 4 is a perspective view schematically showing the state in which the embodiment of the present invention is used.

### DETAILED DESCRIPTION OF THE INVENTION

The present invention is characterized by a transparent display apparatus having a screen direction switching function including a transparent display unit including glass substrates, each of which is made of a transparent material, and an image output means disposed between the glass substrates in the state of being mounted to inner surfaces of the glass substrates for outputting an image signal, a first polarized light source unit disposed at the front of the transparent display unit, the first polarized light source unit being provided at one end thereof with a light emitting diode (LED) lamp, the first polarized light source unit being configured to perform a polarizing function toward the front of the transparent display unit using light emitted from the LED lamp, a second polarized light source unit disposed at the rear of the transparent display unit, the second polarized light source unit being provided at one end thereof with a light emitting diode (LED) lamp, the first polarized light source unit being configured to perform a polarizing function toward the rear of the transparent display unit using light emitted from the LED lamp, and a setting controller for performing control such that the transparent display unit, the first polarized light source unit, and the second polarized light source unit are individually powered on or off, the setting controller being configured to apply control signals to the transparent display unit, the first polarized light source unit, and the second polarized light source unit such that a screen output state in a forward direction or a rearward direction of the transparent display apparatus is set for each mode.

Hereinafter, an exemplary embodiment of the transparent display apparatus having the screen direction switching function according to the present invention will be described in detail with reference to the accompanying drawings.

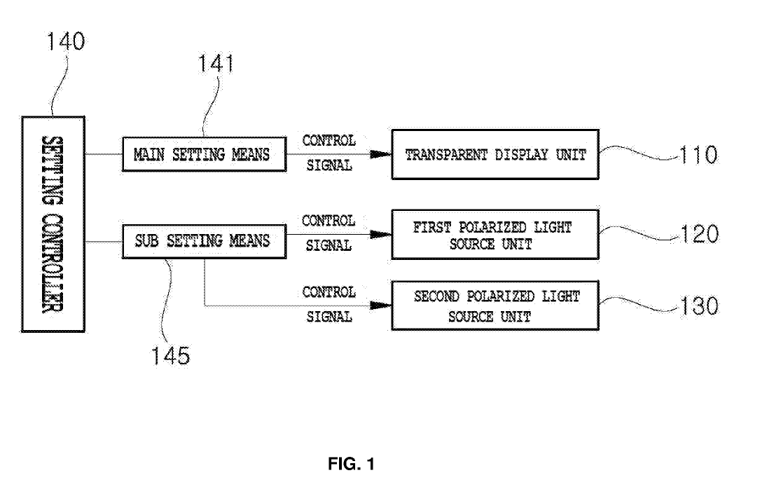

Referring first to FIGS. 1 to 3, an exemplary embodiment of the transparent display apparatus having the screen direction switching function according to the present invention includes a transparent display unit 110, a first polarized light source unit 120, a second polarized light source unit 130, and a setting controller 140.

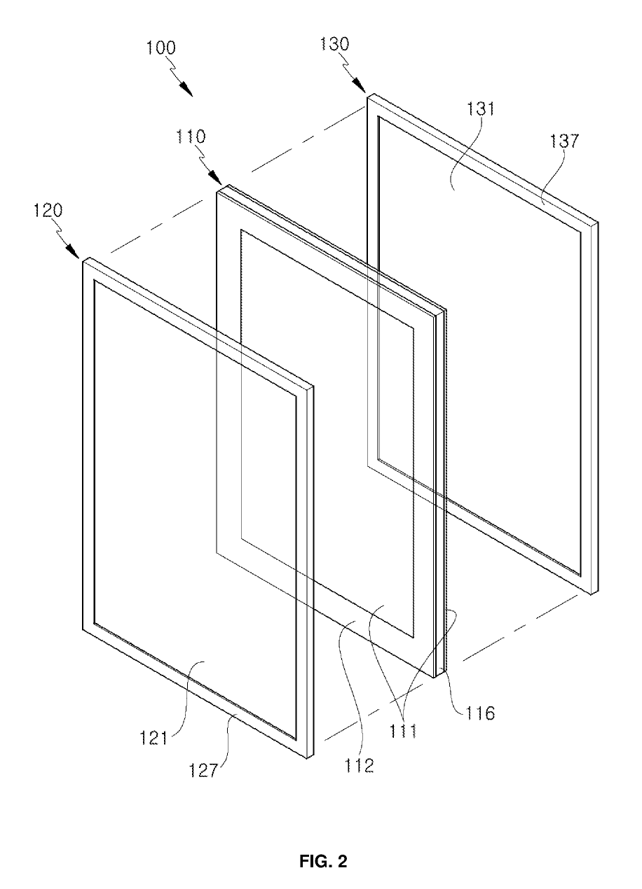

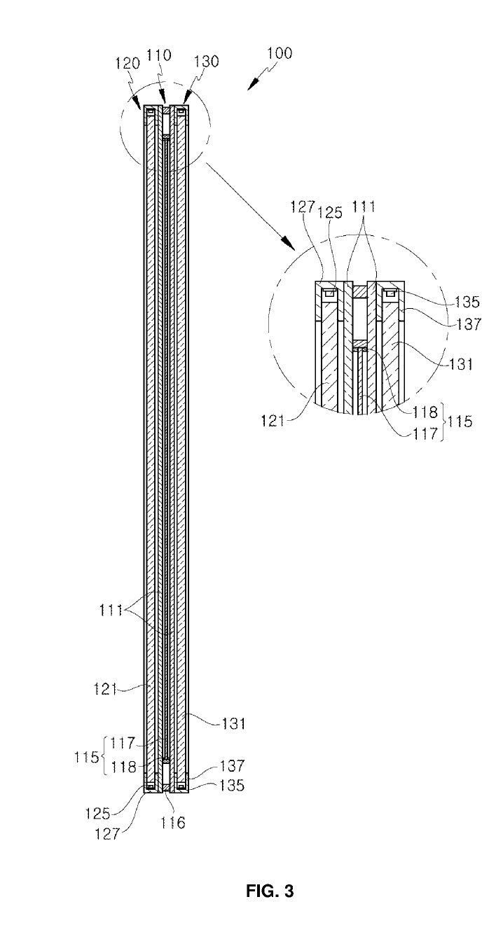

As shown in FIGS. 2 and 3, the transparent display unit 110 is configured to have the structure of a multi-layered substrate. The transparent display unit 110 includes glass substrates 111 and an image output means 115.

The transparent display unit 110 is configured to have a structure in which the glass substrates 111 and the image output means 115 are stacked in the state in which the glass substrates 111 and the image output means 115 are spaced apart from each other by a predetermined distance.

Each of the glass substrates 111 is formed in the shape of a plate. Each of the glass substrates 111 is made of a transparent glass material.

Each of the glass substrates 111 may be provided on the edge of at least one of the front and rear surfaces thereof with a cell 112, which may be dark-colored (e.g. black). The cell 112 may be formed by deposition or silk screen printing such that the cell 112 has a predetermined pattern.

The cell 122 may be adhered to the surface of each of the glass substrates 111 using an optically clear adhesive.

In the case in which the cell 112 is formed on each of the glass substrates 111, screen definition is improved. In addition, each of the glass substrates 111 transmits about 97% or more of light, since the optically clear adhesive is used. Consequently, each of the glass substrates 111 may function as glass.

A spacing member 116 is disposed between the glass substrates 111, which are disposed in the forward-rearward direction, such that the glass substrates 111 are spaced apart from each other by a predetermined distance.

The spacing member 116 is disposed in contact with the edges of corresponding surfaces of the glass substrates 111. The spacing member 116 may be bonded to the edges of corresponding surfaces of the glass substrates 111 using silicon such that the state in which the spacing member 116 is bonded to the edges of corresponding surfaces of the glass substrates 111 is maintained.

The image output means 115 is disposed between the glass substrates 111 in the state of being mounted to the inner surfaces of the glass substrates 111. The image output means 115 outputs various image signals that are input from the outside.

The image output means 115 is configured to have a structure that is capable of outputting image signals that are input from the outside. The image output means 115 includes a liquid crystal cell 117, at one side of which a printed circuit board (PCB) (not shown) is mounted, and a spacer 118.

The liquid crystal cell 117 is connected to the PCB via an additional input device such that various image signals are input to the liquid crystal cell 117. The liquid crystal cell 117 is powered on or off under the control of the setting controller 140.

The spacer 118 is made of a silicon material. The spacer 118 functions to support the liquid crystal cell 117 such that the distance between the liquid crystal cell 117 and each of the glass substrates 111 is maintained.

Each of the first polarized light source unit 120 and the second polarized light source unit 130 generates transparent light to perform a polarizing function.

As shown in FIGS. 2 and 3, the first polarized light source unit 120 and the second polarized light source unit 130 are disposed respectively at the front and the rear of the transparent display unit 110. More specifically, the first polarized light source unit 120 is disposed at the front of the transparent display unit 110, and the second polarized light source unit 130 is disposed at the rear of the transparent display unit 110.

The first polarized light source unit 120 and the second polarized light source unit 130 each are configured as a structural body having a polarizing function, but are configured to perform their polarizing functions at different positions. That is, the first polarized light source unit 120 is configured to perform a polarizing function toward the front of the transparent display unit 110, and the second polarized light source unit 130 is configured to perform a polarizing function toward the rear of the transparent display unit 110.

The first polarized light source unit 120 and the second polarized light source unit 130 are configured to generate transparent light at the front and the rear of the transparent display unit 110, respectively. The first polarized light source unit 120 includes a polarizing plate member 121 and a light emitting diode (LED) lamp 125, and the second polarized light source unit 130 includes a polarizing plate member 131 and a light emitting diode (LED) lamp 135.

The polarizing plate members 121 and 131 are located so as to correspond to the transparent display unit 110. A plurality of LED lamps 125 is mounted to the side of the polarizing plate member 121, and a plurality of LED lamps 135 is mounted to the side of the polarizing plate member 131.

Each of the polarizing plate members 121 and 131 is made of a transparent plastic material that exhibits high mechanical strength, is not easily deformed, is lightweight, exhibits high resistance to chemicals, and is capable of effectively transmitting visible light. Specifically, each of the polarizing plate members 121 and 131 is made of poly methyl methacrylate (PMMA).

Although not shown in the figures, a coating layer for scattering light is formed on the surface of each of the polarizing plate members 121 and 131 such that light emitted from the LED lamps 125 and 135 is uniformly distributed over the entire surface of each of the polarizing plate members 121 and 131. That is, the transparencies of the polarizing plate members 121 and 131 are changed by the LED lamps 125 and 135, which emit light.

The coating layer formed on each of the polarizing plate members 121 and 131 has a particle size of 50 to 80 nm. The coating layer is formed on each of the polarizing plate members 121 and 131 by coating a light scattering agent on the surface of each of the polarizing plate members 121 and 131 using a screen printing method.

The LED lamps 125 and 135 are mounted respectively to the sides of the polarizing plate members 121 and 131 so as to be arranged along the sides of the polarizing plate members 121 and 131.

The LED lamps 125 and 135 are configured to emit light toward the polarizing plate members 121 and 131, respectively. The LED lamps 125 and 135 are powered on or off under the control of the setting controller 140. In addition, the intensity of the light emitted from the LED lamps 125 and 135 is controlled by the setting controller 140.

For example, when the LED lamps 125 and 135 of the first polarized light source unit 120 and the second polarized light source unit 130 are powered on under the control of the setting controller 140, the LED lamps 125 and 135 emit light toward the polarizing plate members 121 and 131, respectively. When the LED lamps 125 and 135 of the first polarized light source unit 120 and the second polarized light source unit 130 are powered off under the control of the setting controller 140, the polarizing plate members 121 and 131 become completely visually transparent.

The first polarized light source unit 120 and the second polarized light source unit 130 respectively include lamp frames 127 and 137 formed along the sides of the polarizing plate members 121 and 131 for surrounding the LED lamps 125 and 135 to define light emission spaces, respectively. As a result, light emitted from the LED lamps 125 and 135 may be concentrated onto the polarizing plate members 121 and 131, respectively, thereby minimizing the loss of light.

As shown in FIG. 1, the setting controller 140 applies different control signals to the transparent display unit 110, the first polarized light source unit 120, and the second polarized light source unit 130.

The setting controller 140 performs control such that the transparent display unit 110, the first polarized light source unit 120, and the second polarized light source unit 130 are individually powered on or off. To this end, the setting controller 140 applies control signals to the transparent display unit 110, the first polarized light source unit 120, and the second polarized light source unit 130 such that the screen output state in the forward direction or the rearward direction of the transparent display apparatus is set for each mode.

The setting controller 140 includes a main setting means 141 configured to apply a control signal to the transparent display unit 110 in order to select a basic mode and a sub setting means 145 configured to apply control signals to the first polarized light source unit 120 and the second polarized light source unit 130 in order to select one of the detailed modes, which are based on the forward direction and the rearward direction of the transparent display apparatus.

The setting controller 140 controls the transparent display unit 110 using the main setting means 141 in order to select a transparent mode or a shading mode based on whether or not the screen is output. More specifically, the setting controller 140 performs control such that the transparent display unit 110 is powered on or off using the main setting means 141 in order to select a transparent mode or a shading mode in the state in which the screen is output in the forward direction or the rearward direction of the transparent display apparatus through the first polarized light source unit 120 or the second polarized light source unit 130.

For example, when the transparent display unit 110 is powered on using the main setting means 141, a transparent mode, in which the screen is output in opposite directions in the state in which the transparent display unit 110 is transparent at the front and the rear thereof, is set. When the transparent display unit 110 is powered off using the main setting means 141, a shading mode, in which the transparent display unit 110 is opaque at the front and the rear thereof, is set.

In the transparent mode or the shading mode, which is set using the main setting means 141, the setting controller 140 may set a detailed output mode using the sub setting means 145.

In the transparent mode, in which the transparent display unit 110 is powered on, the setting controller 140 may select one from between a selective screen viewing mode and an illumination mode based on the general transparent mode, in which the screen is output in both directions.

When the selective screen viewing mode is selected, the setting controller 140 may switch from the general transparent mode, i.e. a bidirectional screen output state, in which the screen is output from the transparent display unit 110 in opposite directions, to a unidirectional screen output state, in which the screen is output from the front or the rear of the transparent display unit 110 depending on whether the first polarized light source unit 120 and the second polarized light source unit 130 are turned on or off. More specifically, when the first polarized light source unit 120 is turned on and the second polarized light source unit 130 is turned off using the sub setting means 145, it is possible to switch to the state in which the screen is output from the rear of the transparent display unit 110 based on a polarizing function of the first polarized light source unit 120. In the transparent mode, in which the transparent display unit 110 is powered on, when the first polarized light source unit 120 is turned off and the second polarized light source unit 130 is turned on using the sub setting means 145, it is possible to switch to the state in which the screen is output from the front of the transparent display unit 110 based on a polarizing function of the second polarized light source unit 130.

In the case in which the screen is output in one direction in the selective screen viewing mode, which is selected by the setting controller 140, as described above, the first polarized light source unit 120 or the second polarized light source unit 130 performs the polarizing function as the result of being turned on, whereby it is possible to improve the visibility of an image output from the transparent display unit 110.

In the transparent mode, in which the transparent display unit 110 is powered on, the setting controller 140 may perform control such that both the first polarized light source unit 120 and the second polarized light source unit 130 are turned on in order to select the illumination mode. That is, when both the first polarized light source unit 120 and the second polarized light source unit 130 are turned on, the polarizing functions of the first polarized light source unit 120 and the second polarized light source unit 130 are performed at the front and the rear of the transparent display unit 110. As a result, a visual shading state is achieved, whereby the illumination state is maintained at the front and the rear of the transparent display unit 110.

In addition, in the shading mode, in which the transparent display unit 110 is powered off, the setting controller 140 may select one from between a unidirectional illumination mode and a bidirectional illumination mode based on the general bidirectional shading mode.

The general bidirectional shading mode, which is selected by the setting controller 140, is a physical shading mode, in which the both the first polarized light source unit 120 and the second polarized light source unit 130 are turned off.

When the unidirectional illumination mode is selected using the sub setting means 145 in the shading mode of the transparent display unit 110, which is selected using the main setting means 141, the setting controller 140 may perform control such that light is emitted from the front or the rear of the transparent display unit 110 depending on whether the first polarized light source unit 120 and the second polarized light source unit 130 are turned on or off. More specifically, when the first polarized light source unit 120 is turned off and the second polarized light source unit 130 is turned on using the sub setting means 145, it is possible to emit light to the second polarized light source unit 130 (i.e. to the rear of the transparent display unit 110) while maintaining the shading mode on the first polarized light source unit 120. In the shading mode, in which the transparent display unit 110 is powered off, when the first polarized light source unit 120 is turned on and the second polarized light source unit 130 is turned off using the sub setting means 145, it is possible to emit light to the first polarized light source unit 120 (i.e. to the front of the transparent display unit 110) while maintaining the shading mode on the second polarized light source unit 130.

In the shading mode, in which the transparent display unit 110 is powered off, the setting controller 140 may perform control such that both the first polarized light source unit 120 and the second polarized light source unit 130 are turned on in order to perform the bidirectional illumination mode.

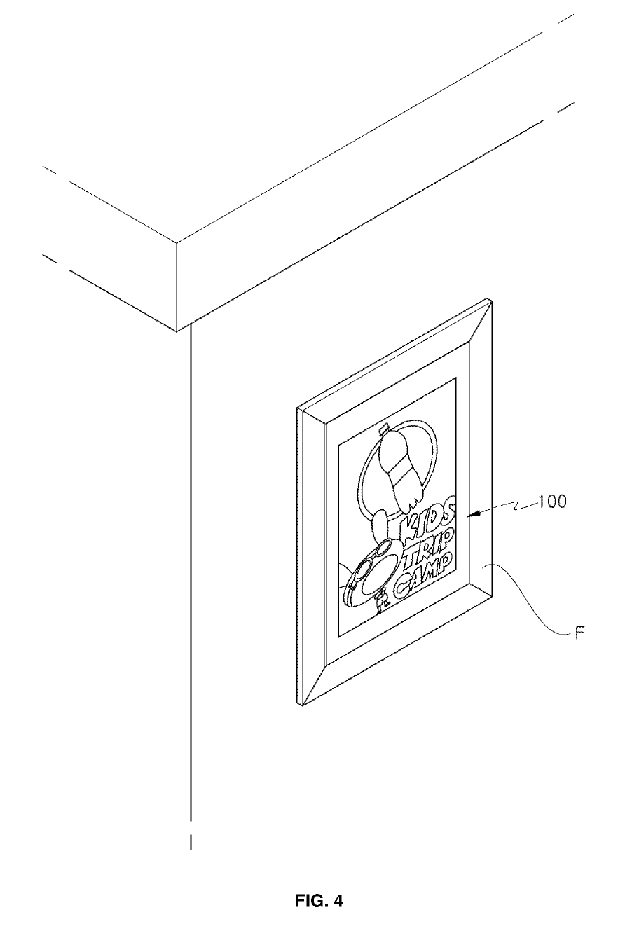

As shown in FIG. 4, the transparent display apparatus 100 having the screen direction switching function with the above-stated construction according to the present invention may be coupled to a window frame F, which may be mounted to the wall of a building so as to have various structures. In other words, the transparent display apparatus 100 may be provided as a window type transparent display apparatus configured such that the screen may be output in one selected from between the indoor direction and the outdoor direction.

As is apparent from the above description, in the transparent display apparatus having the screen direction switching function according to the present invention, the first polarized light source unit, which has a polarizing function, and the second polarized light source unit, which has a polarizing function, are disposed at the front and the rear of the transparent display unit, respectively, such that the state in which the screen is output in the forward direction and/or the rearward direction is set for each mode. Consequently, it is possible to output various kinds of screens based on a mode that is flexibly set according to circumstances at the front and the rear of the transparent display unit and to greatly improve the visibility of the screen irrespective of the surrounding conditions, such as the time of day.

In addition, in the transparent display apparatus having the screen direction switching function according to the present invention, it is possible to select the transparent mode or the shading mode in the state in which the screen is output from the front and the rear of the transparent display unit. In the case in which the transparent display apparatus is provided as a window type transparent display apparatus, therefore, it is possible to greatly improve the utility and functionality of the product while constituting appropriate transparent and shading environments based on the surrounding conditions, such as the time of day.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A transparent display apparatus having a screen direction switching function comprising:
a transparent display unit comprising glass substrates, each of which is made of a transparent material, and an image output means disposed between the glass substrates in a state of being mounted to inner surfaces of the glass substrates for outputting an image signal;
a first polarized light source unit disposed at a front of the transparent display unit, the first polarized light source unit being provided at one end thereof with a light emitting diode (LED) lamp, the first polarized light source unit being configured to perform a polarizing function toward the front of the transparent display unit using light emitted from the LED lamp;
a second polarized light source unit disposed at a rear of the transparent display unit, the second polarized light source unit being provided at one end thereof with a light emitting diode (LED) lamp, the first polarized light source unit being configured to perform a polarizing function toward the rear of the transparent display unit using light emitted from the LED lamp; and
a setting controller for performing control such that the transparent display unit, the first polarized light source unit, and the second polarized light source unit are individually powered on or off, the setting controller being configured to apply control signals to the transparent display unit, the first polarized light source unit, and the second polarized light source unit such that a screen output state in a forward direction or a rearward direction of the transparent display apparatus is set for each mode.

2. The transparent display apparatus according to claim 1, wherein
the first polarized light source unit and the second polarized light source unit each comprise a polarizing plate member disposed so as to correspond to the transparent display unit, the polarizing plate member being provided at a side thereof with a plurality of LED lamps, and
the polarizing plate member is made of poly methyl methacrylate (PMMA).

3. The transparent display apparatus according to claim 1, wherein the setting controller performs control such that the transparent display unit is powered on or off in order to select a transparent mode or a shading mode in a state in which the screen is output in the forward direction or the rearward direction of the transparent display apparatus through the first polarized light source unit and the second polarized light source unit.

4. The transparent display apparatus according to claim 3, wherein
in the transparent mode, in which the transparent display unit is powered on, the setting controller performs control such that the first polarized light source unit is turned on and the second polarized light source unit is turned off in order to switch to a state in which the screen is output from the rear of the transparent display unit based on the polarizing function of the first polarized light source unit, and
in the transparent mode, in which the transparent display unit is powered on, the setting controller performs control such that the first polarized light source unit is turned off and the second polarized light source unit is turned on in order to switch to a state in which the screen is output from the front of the transparent display unit based on the polarizing function of the second polarized light source unit.

5. The transparent display apparatus according to claim 3, wherein, in the transparent mode, in which the transparent display unit is powered on, the setting controller performs control such that both the first polarized light source unit and the second polarized light source unit are turned on in order to execute an illumination mode at the front and the rear of the transparent display unit.

6. The transparent display apparatus according to claim 3, wherein
in the shading mode, in which the transparent display unit is powered off, the setting controller performs control such that the first polarized light source unit is turned off and the second polarized light source unit is turned on in order to execute an illumination mode on the second polarized light source unit while maintaining the shading mode on the first polarized light source unit, and
in the shading mode, in which the transparent display unit is powered off, the setting controller performs control such that the first polarized light source unit is turned on and the second polarized light source unit is turned off in order to execute an illumination mode on the first polarized light source unit while maintaining the shading mode on the second polarized light source unit.

7. The transparent display apparatus according to claim 3, wherein, in the shading mode, in which the transparent display unit is powered off, the setting controller performs control such that both the first polarized light source unit and the second polarized light source unit are turned on in order to execute an illumination mode in both the forward direction and the rearward direction of the transparent display apparatus.
